(19) United States
(12) Patent Application Publication
(10) Pub. No.: US 2024/0393710 A1
(43) Pub. Date: Nov. 28, 2024

(54) IMAGE FORMING APPARATUS AND METHOD OF CONTROLLING SAME

(71) Applicant: TOSHIBA TEC KABUSHIKI KAISHA, Tokyo (JP)

(72) Inventor: Koji Takahashi, Sumida Tokyo (JP)

(21) Appl. No.: 18/442,244

(22) Filed: Feb. 15, 2024

(30) Foreign Application Priority Data
May 26, 2023 (JP) 2023-086801

(51) Int. Cl. G03G 15/02; G03G 15/00; G03G 15/16

(52) U.S. Cl. CPC G03G 15/0266; G03G 15/0216; G03G 15/16; G03G 15/5054

(57) ABSTRACT

An image forming apparatus includes an image supporter, a charger, a toner image forming device, a transfer device, a detector, and a controller. The charger includes a charging member adjacent to the surface of the image supporter, and applies a voltage obtained by superimposing an AC voltage on a DC voltage to a charging member to thereby homogenously charge the surface of the image supporter. The toner image forming device forms a latent image provided to the image supporter and then develop the latent image. The transfer device transfers the toner image to a transfer body. The detector detects a resistance value of the transfer device. The controller estimates a saturation value of a surface potential of the image supporter, and then sets a peak value of the AC voltage which is applied by the charger to the charging member, in accordance with the saturation value estimated.

### CROSS-REFERENCE TO RELATED APPLICATION

This application is based upon and claims the benefit of priority from Japanese Patent Application No. 2023-086801, filed on May 26, 2023, the entire contents of which are incorporated herein by reference.

### FIELD

The present disclosure relates to an image forming apparatus and a method of controlling an image forming apparatus.

### BACKGROUND

Image forming apparatuses using electrophotography are widely used as image forming apparatuses installed in workplaces. Such an image forming apparatus using the electrophotography is provided with an image supporter on which an electrostatic latent image is formed, a charging unit which applies a voltage to a charging member adjacent to a surface of the image supporter to thereby homogenously charge the surface of the image supporter, an exposure unit for forming the latent image on the image supporter, a developing unit which approaches the image supporter to perform image development, a primary transfer unit which transfers a toner image on the image supporter thus developed to a transfer body, a secondary transfer unit which transfers the toner image having been transferred to the transfer body to a sheet of paper, an image supporter cleaner which makes contact with the image supporter to remove a residual toner after the transfer, and a transfer body cleaner which makes contact with the transfer body to remove the residual toner after the transfer.

In the charging unit of such an image forming apparatus using the electrophotography, there is adopted a charging-roller system on the grounds that an amount of ozone emitted at the time of discharge is smaller than that of a scorotron charging system.

In this charging-roller system, an input voltage system which performs AC-superimposition on DC power is often selected in view of the fact that a discharge amount is large, and a charge performance is stable. It is generally known that an AC peak voltage (Vp-p) which is a peak value of an AC voltage to be applied to the charging roller is set to a level equal to or higher than double of a DC discharge starting voltage in order to make a charge potential of the surface of the image supporter (hereinafter abbreviated as a surface potential) converge in the vicinity of a DC voltage. At the same time, it is known that when increasing the AC peak voltage, the discharge amount increases, and the ozone concentration in the vicinity of the image supporter rises in accordance with the increase in the discharge amount to promote deterioration of the image supporter, and therefore the endurable number of sheets printed extremely decreases. In order to solve this problem, it is desirable to set the AC peak voltage to a value around the start of a saturation of the surface potential of the image supporter.

As a control system for setting the AC peak voltage to such a value around the start of the saturation of the surface potential of the image supporter, a variety of systems are proposed. For example, there is known a system which measures a DC or AC current flowing from a high-voltage power supply to the charging roller, then compares the result with a DC or AC current reference value assumed to be the value around the start of the saturation of the surface potential of the image supporter to vary the input voltage so as to match the current reference value. Here, the current reference value is a value estimated from the temperature and the moisture when measuring the current flowing from the high-voltage power supply to the charging roller, an operation count correlated with a charging roller resistance, and image supporter film thickness information.

However, in such a control system, there is included a lot of errors such as an error in the temperature and the moisture between a measurement location and the vicinity of the charging roller, an error caused by an individual difference of the charging roller resistance value when the number of sheets printed proceeds, and an error caused by an individual difference in image supporter membrane abrasion at a predetermined rotation speed. Therefore, the current reference value cannot be obtained with an appropriate accuracy in some cases, and as a result, there occurs when the AC peak voltage cannot correctly be set.

### DESCRIPTION OF THE DRAWINGS

FIG. 1 is a block diagram showing an example of a configuration of an image forming apparatus.

FIG. 2 is a diagram showing an example of a configuration of a printer.

FIG. 3 is a graph showing a relationship between an AC peak voltage and a surface potential of an image supporter.

FIG. 4 is a graph which shows the relationship between the AC peak voltage and the surface potential of the image supporter, and which describes an effect exerted by a change in resistance of a charging roller.

FIG. 5 is a graph which shows the relationship between the AC peak voltage and the surface potential of the image supporter, and which describes an effect exerted by a change in film thickness of a photosensitive layer of the image supporter.

FIG. 6 is a graph showing a relationship between the surface potential of the image supporter and a resistance detecting voltage.

FIG. 7 is a graph showing a relationship between the AC peak voltage and the surface potential of the image supporter, and a relationship between the AC peak voltage and the resistance detecting voltage.

FIG. 8 is a diagram showing an example of a memory content of a resistance detecting voltage storage unit.

FIG. 9 is a diagram showing an example of a memory content of an AC peak voltage storage unit.

FIG. 10 is a flowchart representing an example of a processing operation of the image forming apparatus.

FIG. 11 is a flowchart representing an example of AC peak voltage control processing.

### DETAILED DESCRIPTION

When the AC peak voltage is set higher or lower, and accordingly the surface potential of the image supporter becomes higher or lower, a problem such as white background fogging or carrier scattering occurs in some cases in the image development by the developing unit, which incurs a significant deterioration of print quality.

The problem to be solved by the present disclosure is to provide an image forming apparatus which makes it possible to correctly set the AC voltage peak value to a value around the start of the saturation of the surface potential of the image supporter.

In an embodiment, an image forming apparatus includes an image supporter, a charger, a toner image forming device, a transfer device, a detector, and a controller. The image supporter is provided with an electrostatic latent image. The charger includes a charging member adjacent to the surface of the image supporter, and applies a voltage obtained by superimposing an AC voltage on a DC voltage to a charging member to thereby homogenously charge the surface of the image supporter. The toner image forming device forms a latent image to be provided to the image supporter and then develop the latent image to thereby form a toner image on the image supporter. The transfer device transfers the toner image on the image supporter to a transfer body. The detector detects a resistance value of the transfer device. The controller estimates a saturation value of a surface potential of the image supporter based on the resistance value of the transfer device detected by the detector, and then sets a peak value of the AC voltage which is applied by the charger to the charging member, in accordance with the saturation value estimated.

An image forming apparatus according to an embodiment will hereinafter be described using the drawings. It should be noted that in each of the drawings used for describing the following embodiment, scale sizes of the respective parts will appropriately be changed. Further, in each of the drawings used for describing the following embodiment, constituents are omitted as appropriate for the sake of convenience of explanation.

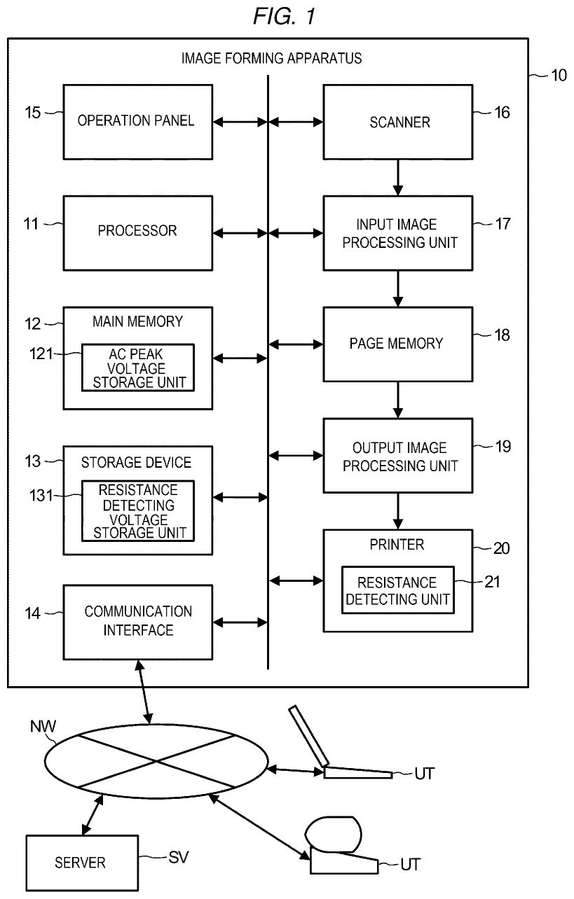

FIG. 1 is a block diagram showing a configuration example of the image forming apparatus 10 according to the embodiment.

The image forming apparatus 10 is one of multi-function peripherals (hereinafter abbreviated as MFP) which are installed in a workplace, and are provided with at least a scanning function and a printing function. As shown in FIG. 1, the image forming apparatus 10 is provided with a processor 11, a main memory 12, a storage device 13, a communication interface 14, an operation panel 15, a scanner 16, an input image processing unit 17, a page memory 18, and output image processing unit 19, a printer 20, and so on. These units are coupled to each other with a data bus or the like.

It should be noted that the image forming apparatus 10 can be provided with a necessary constituent in addition to the constituents shown in FIG. 1, or a specific constituent can be eliminated from the constituents shown in FIG. 1.

The processor 11 is, for example, a CPU (central processing unit), but is not limited thereto. The processor 11 can be a multi-core processor or a multithread processor, which is capable of executing parallel processing. Further, the processor 11 can also be an MPU (micro processing unit). The processor 11 has a function of controlling an overall operation of the image forming apparatus 10. The processor 11 can be provided with an internal memory, a variety of types of interfaces, and so on. The processor 11 executes a program which is stored in advance in the internal memory, the storage device 13, or the like to thereby realize a variety of types of processing.

It should be noted that some of the variety of types of functions to be realized by the processor 11 executing the program can be those to be realized by a hardware circuit of a variety of types including integrated circuits such as an ASIC (Application Specific Integrated Circuit), a DSP (Digital Signal Processor), an FPGA (Field-Programmable Gate Array), a GPU (Graphics Processing Unit), an SoC (System on a Chip), and a PLD (Programmable Logic Device). In this case, the processor 11 controls the functions to be executed by the hardware circuit.

The main memory 12 is a volatile memory. The main memory 12 is a working memory or a buffer memory. The main memory 12 is capable of storing a variety of application programs based on a command from the processor 11. Further, the main memory 12 can store data necessary for execution of a control program and the application program stored in the storage device 13, an execution result of those programs, and so on. For example, the main memory 12 stores an AC peak voltage storage unit 121 and so on. The AC peak voltage storage unit 121 stores an AC peak voltage as a peak value of an AC voltage to be applied to a charging roller described later of the printer 20. Details of the AC peak voltage storage unit 121 will be described later.

The storage device 13 is a nonvolatile memory to which data can be written, and to which data can be rewritten. The storage device 13 is formed of, for example, an HDD (Hard Disk Drive), an SSD (Solid State Drive), or a flash memory. The storage device 13 stores the control program, the application program, a variety of types of data, and so on in accordance with an operational purpose of the image forming apparatus 10. For example, the storage device 13 stores a print job transmitted from a user terminal described later, a resistance detecting voltage storage unit 131, and so on. The print job includes print target data such as character data or image data as an origin of an image to be formed on a sheet. The print target data can be data for forming an image on a single sheet, or can also be data for forming an image on two or more sheets. Further, the print job can include information representing whether to perform color printing or to perform black-and-white printing, information of print copies (the number of sets of pages), information of the number of sheets printed (the number of pages) per copy, and so on. Further, the resistance detecting voltage storage unit 131 stores a resistance detecting voltage, which is a voltage in a primary transfer unit described later of the printer 20, and which is detected when changing the AC peak voltage. Details of the resistance detecting voltage storage unit 131 will be described later.

The communication interface 14 is an interface for communicating with an external device on a network NW. The communication interface 14 is used for communication with the user terminal UT located in the workplace, a server device SV, and so on via the network NW such as an internal LAN (Local Area Network). The communication interface 14 is configured as, for example, a LAN connector. Further, the communication interface 14 can also be what performs wireless communication with other equipment in compliance with a standard such as Bluetooth (registered trademark) or Wi-Fi (registered trademark). It should be noted that FIG. 1 shows just two user terminals UT, but it is obvious that the number of the user terminals UT is not limited thereto.

To the operation panel 15, there are input a variety of instructions by the operator of the image forming apparatus 10. The operation panel 15 transmits a signal representing the instruction input by the operator to the processor 11. The operation panel 15 is provided with, for example, a keyboard, a numerical keypad, and a touch panel as an operation unit.

Further, the operation panel 15 displays a variety of types of information to the operator of the image forming apparatus 10. Specifically, the operation panel 15 displays a screen showing a variety of types of information based on signals from the processor 11. The operation panel 15 is provided with a monitor such as a liquid crystal display as a display unit.

The scanner 16 optically scans a document to read an image of the document as image data. The scanner 16 reads the document as a color image. The scanner 16 is formed of a sensor array formed in a main scanning direction. The scanner 16 moves the sensor array in a sub-scanning direction to read the whole of the document.

The input image processing unit 17 processes the image data read by the scanner 16. Further, although not shown in FIG. 1, when the image forming apparatus 10 is provided with a reader for a storage medium such as a USB memory, the input image processing unit 17 can process the image data read out from the storage medium. Further, the input image processing unit 17 converts the print target data such as the character data or the image data included in the print job stored in the storage device 13 into the image data representing the image to be formed.

The page memory 18 stores the image data which has been processed by the input image processing unit 17.

The output image processing unit 19 processes the image data stored by the page memory 18 so that the printer 20 can print the image data on a sheet.

The printer 20 prints the image data which has been processed by the output image processing unit 19 on the sheet based on control by the processor 11. The printer 20 prints the image data on the sheet with, for example, the electrophotography. Further, the printer 20 is formed of a transfer body, rollers for driving the transfer body, a photoconductor drum, a resistance detecting unit 21, and so on. Details of the printer 20 will be described later.

The resistance detecting unit 21 detects a resistance value of the primary transfer unit as a voltage value. The resistance detecting unit 21 outputs the resistance detecting voltage which represents the voltage value thus detected, to the processor 11. As described later, the processor 11 stores the resistance detecting voltage in the resistance detecting voltage storage unit 131.

Then, the printer 20 will be described.

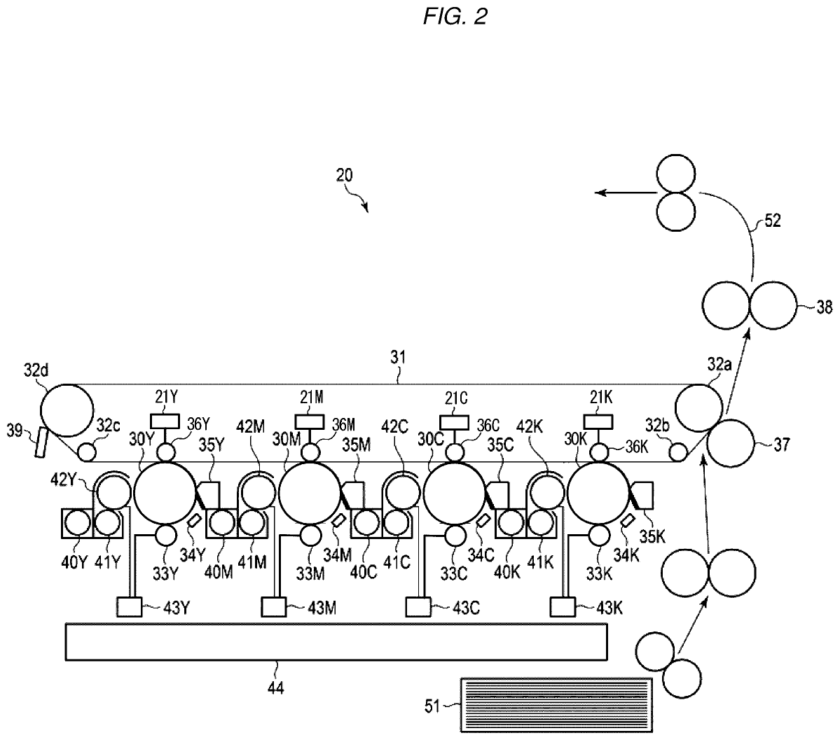

FIG. 2 is a diagram showing a configuration example of the printer 20. As shown in FIG. 2, the printer 20 is provided with resistance detecting units 21K, 21C, 21M, and 21Y, photoconductor drums 30K, 30C, 30M, and 30Y, a transfer body 31, rollers 32a, 32b, 32c, and 32d, charging rollers 33K, 33C, 33M, and 33Y, destaticizers 34K, 34C, 34M, and 34Y, photoconductor cleaners 35K, 35C, 35M, and 35Y, primary transfer rollers 36K, 36C, 36M, and 36Y, a secondary transfer roller 37, a fixing unit 38, a transfer body cleaner 39, developing units 40K, 40C, 40M, and 40Y, agitators 41K, 41C, 41M, and 41Y, developing rollers 42K, 42C, 42M, and 42Y, voltage application units 43K, 43C, 43M, and 43Y, an exposure unit 44, a paper cassette 51, a conveyance path 52, and so on.

The transfer body 31 is an intermediate transfer body. The transfer body 31 is formed to be shaped like an endless belt. Specifically, the transfer body 31 is formed to have an annular shape with a predetermined width.

The rollers 32a through 32d are rollers for driving the transfer body 31. The rollers 32a through 32d are formed inside the transfer body 31. The rollers 32a through 32d stretch the transfer body 31 from inside with predetermined tensile force to form the transfer body 31 like a plane. The rollers 32a through 32d rotate with drive force from a drive unit. The rollers 32a through 32d rotate to thereby drive the transfer body 31. It should be noted that some of the rollers 32a through 32d can passively be rotated.

The printer 20 is provided with the resistor detecting unit, the photoconductor drum, the charging roller, the destaticizer, the photoconductor cleaner, the primary transfer roller, the developing unit, the agitator, the developing roller, the voltage application unit, and a laser unit in the exposure unit 44 for each color of the toner. Here, the printer 20 is provided with the resistor detecting unit, the photoconductor drum, the charging roller, the destaticizer, the photoconductor cleaner, the primary transfer roller, the developing unit, the agitator, the developing roller, the voltage application unit, and the laser unit for each of the cyan (C) toner, the magenta (M) toner, the yellow (Y) toner, and the black (K) toner. It should be noted that the color of the toner is not limited to each of the C, M, Y, and K colors, and can also be any other color. Further, the toner can also be a special toner. For example, the toner can be a decolorable toner which is decolored at a temperature higher than a predetermined temperature, and comes into an invisible state.

In the present embodiment, the printer 20 is provided with the resistance detecting units 21K, 21C, 21M, and 21Y as the resistance detecting units. The photoconductor drums 30Y, 30M, 30C, and 30K are provided as the photoconductor drums. Further, the printer 20 is provided with the charging rollers 33Y, 33M, 33C, and 33K as the charging rollers. Further, the printer 20 is provided with the destaticizers 34Y, 34M, 34C, and 34K as the destaticizers. Further, the printer 20 is provided with the photoconductor cleaners 35Y, 35M, 35C, and 35K as the photoconductor cleaners.

Further, the printer 20 is provided with the primary transfer rollers 36Y, 36M, 36C, and 36K as the primary transfer rollers. Further, the printer 20 is provided with the developing units 40Y, 40M, 40C, and 40K as the developing units. Further, the printer 20 is provided with the agitators 41Y, 41M, 41C, and 41K as the agitators. Further, the printer 20 is provided with the developing rollers 42Y, 42M, 42C, and 42K as the developing rollers. Further, the printer 20 is provided with the voltage application units 43Y, 43M, 43C, and 43K as the voltage application units.

Here, as the representatives, the resistor detecting unit 21K, the photoconductor drum 30K, the charging roller 33K, the destaticizer 34K, the photoconductor cleaner 35K, the primary transfer roller 36K, the developing unit 40K, the agitator 41K, the developing roller 42K, and the voltage application unit 43K will be described.

The developing unit 40K is a container for containing a developer including the toner and a magnetized carrier. The developing unit 40K receives the toner fed from a toner cartridge. The developer is contained in the developing unit 40K at the time of manufacture, at the start of use, or the like.

In the developing unit 40K, there is formed the agitator 41K. The agitator 41K agitates the developer in the developing unit 40K. The agitator 41K is formed of a screw for agitating the developer, a motor for rotating the screw, and so on.

Further, in the developing unit 40K, there is formed the developing roller 42K. The developing roller 42K attracts the developer with a magnet incorporated therein, and then rotates inside the developing unit 40K to thereby make the developer adhere to the surface thereof. The developing roller 42K is rotated by a motor or the like. The developing roller 42K is one of rotating members for forming a toner image on the transfer body 31.

The voltage application unit 43K applies a developing bias to the developing roller 42K in accordance with the control of the processor 11. For example, the voltage application unit 43K applies the developing bias to the developing roller 42K. The toner of the developer which adheres to the developing roller 42K adheres to the photoconductor drum 30K as an image supporter due to an electrical field generated by the developing bias and the drum potential to form a toner image.

The charging roller 33K as a charging member approaches the surface of the photoconductor drum 30K to charge the surface of the photoconductor drum 30K at a uniform potential. The voltage application unit 43K applies a voltage which is obtained by superimposing an AC voltage on a DC voltage to the charging roller 33K in accordance with the control of the processor 11. The charging roller 33K is charged due to this voltage application to thereby charge the photoconductor drum 30K. The charging unit which homogenously charges the surface of the photoconductor drum 30K includes the charging roller 33K and the voltage application unit 43K.

The photoconductor drum 30K is a photoconductor equipped with a drum having a cylindrical shape, and a photosensitive layer formed on a circumferential surface of the drum. The photoconductor drum 30K rotates at constant speed due to the power transmitted from the motor. The photoconductor drum 30K is one of the rotating members for forming the toner image on the transfer body 31.

The photoconductor drum 30K is charged by the charging roller 33K. The photoconductor drum 30K is irradiated with a laser from the laser unit in the exposure unit 44 in the charged state while rotating. As a result, a light area electrostatic latent image is formed by the laser in the photoconductor drum 30K.

The primary transfer roller 36K is formed at a position opposed to the photoconductor drum 30K across the transfer body 31. The primary transfer unit includes the transfer body 31 and the primary transfer roller 36K. The primary transfer roller 36K makes the transfer body 31 come into contact with the photoconductor drum 30K, and is set to a positive polarity as an opposite potential to the surface of the photoconductor drum 30K to thereby attract the toner on the surface of the photoconductor drum 30K. Thus, the primary transfer roller 36K transfers the toner image formed on the photoconductor drum 30K to the transfer body 31. The photoconductor drum 30K is one of the rotating members for forming the toner image. The primary transfer roller 36K is one of the rotating members for forming the toner image on the transfer body 31. The primary transfer unit which transfers the toner image on the photoconductor drum 30K as the image supporter to the transfer body 31 includes the transfer body 31 and the primary transfer roller 36K.

The resistance detecting unit 21K detects a resistance value of a resistive element including the transfer body 31 of the primary transfer unit and the primary transfer roller 36K as a voltage value. For example, the resistance detecting unit 21K detects an applied voltage to the primary transfer roller 36K on which constant current control is performed. The resistance detecting unit 21K outputs a voltage value of the applied voltage thus detected to the processor 11 as the resistance detecting voltage. In the image forming apparatus 10, it is necessary to set an appropriate primary transfer voltage value to the primary transfer roller 36K for preventing an image noise. Therefore, the applied voltage when outputting the predetermined positive constant current to the primary transfer roller 36K is detected with the resistance detecting unit 21K, and the processor 11 sets the primary transfer voltage value when forming the image on the primary transfer roller 36K based on the resistance detecting voltage from the resistance detecting unit 21K. The control processing using the resistance detecting unit 21 for preventing such an image noise will hereinafter referred to as a resistance detection control processing.

The photoconductor cleaner 35K is formed of a blade making contact with the surface of the photoconductor drum 30K, and so on. The photoconductor cleaner 35K removes the toner remaining on the surface of the photoconductor drum 30K using the blade.

The destaticizer 34K removes a residual charge potential of the photoconductor drum 30K.

The paper cassette 51 is a cassette containing the sheets as the medium. The paper cassette 51 has a structure capable of supplying the sheets from the outside of a chassis of the image forming apparatus 10. For example, the paper cassette 51 has a structure which can be drawn from the chassis.

The conveyance path 52 conveys the sheet. For example, the conveyance path 52 picks up the sheet one by one from the paper cassette 51, and then conveys the sheet thus picked up. For example, the conveyance path 52 is formed of rollers, a conveyance belt, and so on.

The secondary transfer roller 37 transfers (performs secondary transfer on) the toner image formed on the transfer body 31 to the sheet. As shown in FIG. 2, the secondary transfer roller 37 is formed at a position across the transfer body 31 from the roller 32a. The secondary transfer roller 37 transfers the toner image on the transfer body 31 to the sheet conveyed by the conveyance path 52.

The fixing unit 38 is formed downstream in the conveyance direction of the sheet from the secondary transfer roller 37. The fixing unit 38 fixes the toner image which has been transferred to the sheet. The fixing unit 38 heats the toner image to a fixing temperature to thereby fix the toner image to the sheet. For example, the fixing unit 38 is formed of a heater and so on.

The transfer body cleaner 39 is formed of a blade making contact with the surface of the transfer body 31, and so on. The transfer body cleaner 39 removes the toner remaining on the surface of the transfer body 31 using the blade.

The exposure unit 44 is called an LSU (Laser Scanning Unit), and irradiates each of the photoconductor drums 30K, 30C, 30M, and 30Y with the laser in accordance with the control of the processor 11. The exposure unit 44 irradiates the photoconductor drums 30K, 30C, 30M, and 30Y with the laser to thereby form an electrostatic latent image on each of the photoconductor drums 30K, 30C, 30M, and 30Y. For example, the exposure unit 44 is formed of a laser unit as an irradiation device for emitting the laser, a polygon mirror for reflecting the laser, and so on.

Due to such a configuration as described hereinabove, the printer 20 forms the toner image on the transfer body 31. The printer 20 transfers the toner image formed on the transfer body 31 to a surface of the sheet using the secondary transfer roller 37. The printer 20 heats the sheet to which the toner image has been transferred to fix the toner image to the sheet using the fixing unit 38. The printer 20 discharges the sheet to which the toner image is fixed to the outside using the conveyance path 52.

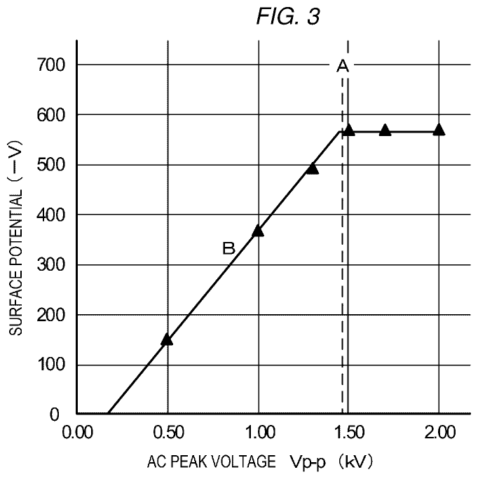

FIG. 3 is a graph showing a relationship between the AC peak voltage (Vp-p) as a peak value of the AC voltage to be applied to the charging roller, and a surface potential Vo as the charge potential of the surface of the photoconductor drum as the image supporter. As described above, the voltages obtained by the voltage application units 43K, 43C, 43M, and 43Y superimposing the AC voltage on the DC power supply are respectively applied to the charging rollers 33K, 33C, 33M, and 33Y. It is generally known that the AC peak voltage (Vp-p) which is the peak value of the AC voltage to be superimposed is set to a level equal to or higher than double of the DC discharge starting voltage in order to make the surface potential Vo of each of the photoconductor drums 30K, 30C, 30M, and 30Y converge in the vicinity of the DC voltage. It is common to set the AC peak voltage (Vp-p) to a value exceeding the vicinity of the saturation value A in the relationship between the AC peak voltage (Vp-p) and the surface potential Vo shown in FIG. 3. Here, the definition of the saturation value A means an inflection point where the gradient B of the relational expression between the AC peak voltage (Vp-p) and the surface potential Vo decreases.

At the same time, it is known that when increasing the AC peak voltage, the discharge amount increases, and the ozone concentration in the vicinity of the photoconductor drums 30K, 30C, 30M, and 30Y rises in accordance with the increase in the discharge amount to promote deterioration of the photoconductor drums 30K, 30C, 30M, and 30Y, and therefore the endurable number of sheets printed extremely decreases. In order to solve this problem, it is necessary to set the AC peak voltage (Vp-p) to a value in the vicinity of the saturation value A.

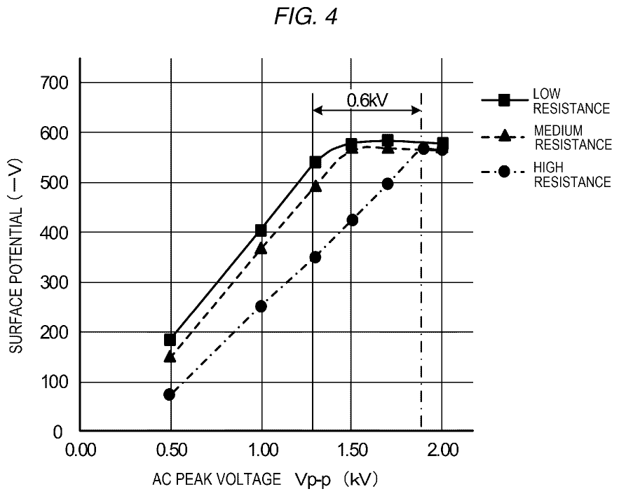

FIG. 4 is a graph showing an influence exerted by a change in resistance of the charging roller. The resistance value of the charging roller changes depending on the temperature and the moisture. The temperature and the moisture of the charging roller depend on a change in environmental temperature, and a fluctuation of the internal moisture of the apparatus due to the number of times or the duration of continuous drive. When the resistance value of the charging roller changes due to the change in temperature and moisture, as shown in FIG. 4, even when applying the same AC peak voltage (Vp-p) to the charging roller, the surface potential of the photoconductor drum fails to be the same, and the point A representing the saturation value changes by about 0.6 kV as a result. It should be noted that regarding the resistance value of the photoconductor drum, the dependency on the temperature and the moisture hardly exists.

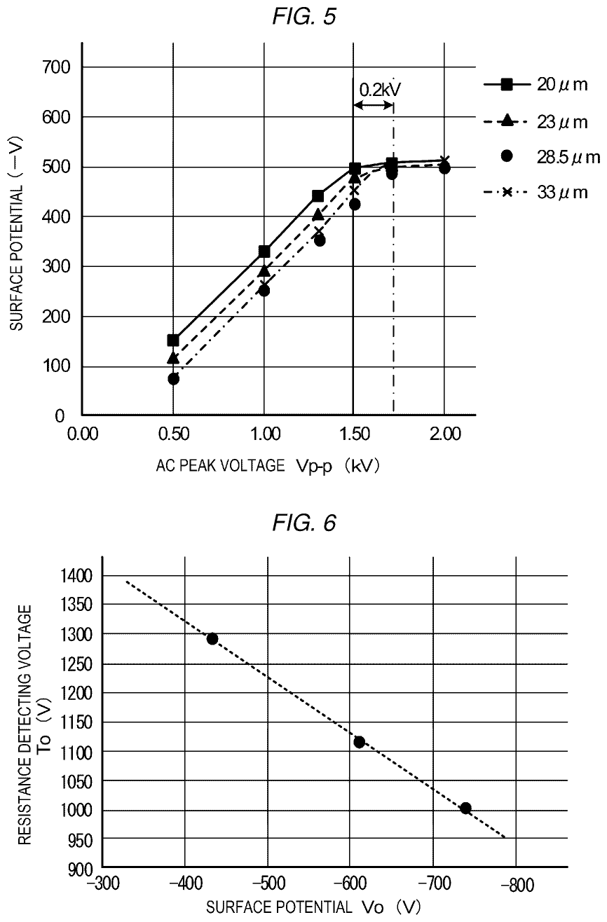

FIG. 5 is a graph showing an influence exerted by a change in film thickness of the photosensitive layer of the photoconductor drum as the image supporter. The film thickness of the photosensitive layer of the photoconductor drum gradually decreases as the number of sheets printed proceeds. As shown in FIG. 5, when the film thickness of the photosensitive layer changes, even when applying the same AC peak voltage (Vp-p) to the charging roller, the surface potential of the photoconductor drum fails to be the same, and the point A representing the saturation value changes as a result. For example, when the film thickness of the photosensitive layer decreases from 33 μm to 20 μm, the saturation value represented by the point A changes by about 0.2 kV.

Here, when the AC peak voltage (Vp-p) is set as a fixed value, there is a possibility that the surface potential Vo fails to reach the saturation value A with that AC peak voltage (Vp-p) when the surface potential Vo of the photoconductor drum changes as shown in FIG. 4 and FIG. 5 due to the resistance value of the charging roller and the film thickness of the photosensitive layer of the photoconductor drum. When the surface potential Vo fails to reach the saturation value A, the problem such as the white background fogging or the carrier scattering occurs in some cases when the developing unit performs the development.

FIG. 6 is a graph showing a relationship between the surface potential Vo of the photoconductor drum as the image supporter and the resistance detecting voltage To detected by the resistance detecting unit 21. As described above, in the image forming apparatus 10, the primary transfer output appropriate for the primary transfer roller is set when forming the image due to the resistance detection control using the resistance detecting unit 21 for preventing the image noise. When executing the resistance detection control, the surface potential (the negative polarity) of the photoconductor drum which acts as an opposite electrode takes any value instead of a certain value, but when the temperature and the moisture in the ambient environment are stable, the potential difference between the surface potential Vo and the resistance detecting voltage To becomes constant during the period of executing the resistance detection control. Therefore, it is known that the resistance detecting voltage To varies by the same amount in accordance with the variation of the surface potential Vo as shown in FIG. 6.

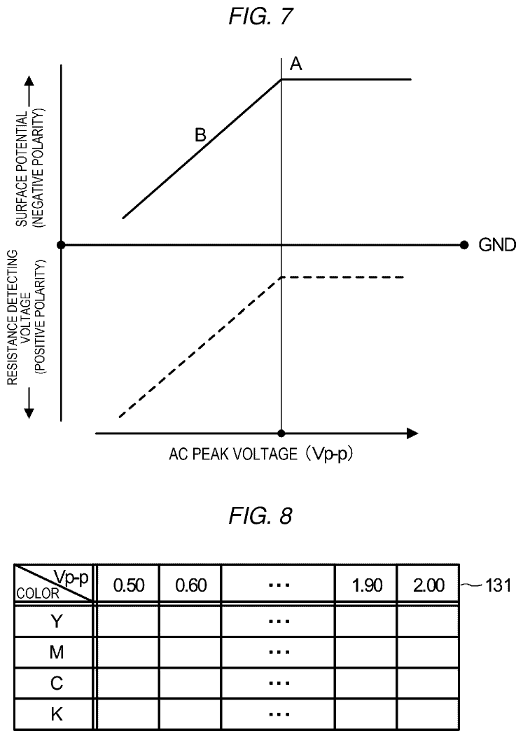

FIG. 7 is a graph showing a relationship between the AC peak voltage (Vp-p) and the surface potential Vo of the photoconductor drum as the image supporter, and a relationship between the AC peak voltage (Vp-p) and the resistance detecting voltage To detected by the resistance detecting unit 21. As described with reference to FIG. 6, when the surface potential Vo changes, the resistance detecting voltage To also changes by the same amount. Therefore, it is possible to estimate the surface potential Vo with the resistance detecting voltage To. Therefore, in the present embodiment, scanning of the AC peak voltage (Vp-p) in which a plurality of voltage setting points is set so as to pass through the saturation value A of the surface potential is performed, and thus, an amount of change of the surface potential Vo corresponding to each of the setting voltages of the AC peak voltage (Vp-p) is detected as an amount of change of the resistance detecting voltage To. Thus, it becomes possible to detect the AC peak voltage (Vp-p) with which the surface potential takes the saturation value A from the saturation value of the resistance detecting voltage To.

FIG. 8 is a diagram showing an example of a memory content of the resistance detecting voltage storage unit 131 provided to the image forming apparatus 10. In the present embodiment, as shown in FIG. 8, the resistance detecting voltage storage unit 131 is realized by a table which stores values with respect to the plurality of voltage setting points set so as to pass through the saturation value A of the surface potential described above for each of the colors of Y, M, C, and K. The values stored in this table are the resistance detecting voltages To detected by the resistance detecting units 21K, 21C, 21M, and 21Y of the respective colors at the AC peak voltages (Vp-p) of the respective voltage setting points.

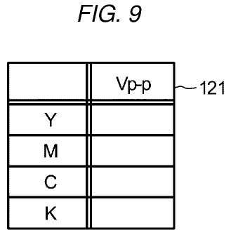

FIG. 9 is a diagram showing an example of a memory content of the AC peak voltage storage unit 121 provided to the image forming apparatus 10. In the present embodiment, as shown in FIG. 9, the AC peak voltage storage unit 121 stores the values set as the AC peak voltages (Vp-p) to be applied to the charging rollers 33K, 33C, 33M, and 33Y with respect to the colors of Y, M, C, and K.

Then, an operation example of the image forming apparatus 10 according to an embodiment will be described.

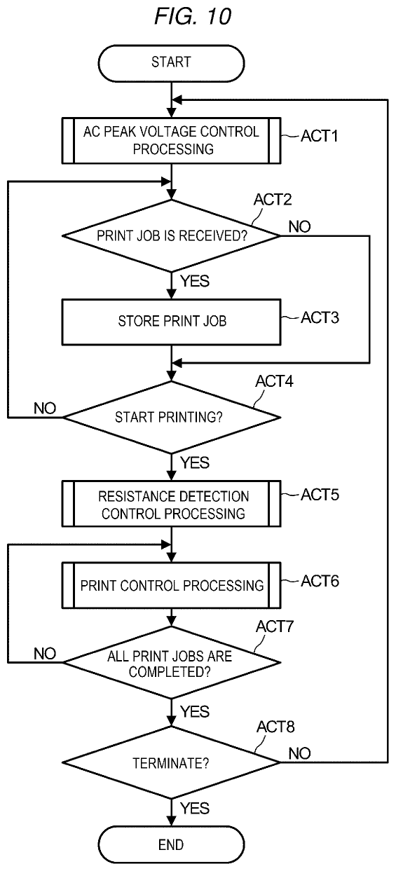

FIG. 10 is a flowchart representing an example of a processing operation of the image forming apparatus 10. It should be noted that the flowchart shown in FIG. 10 represents only the print processing while omitting the printing of a scanned document, namely copy processing, since only the print target is different therebetween. Further, the contents of the processing which is shown in FIG. 10 and is described below are illustrative only, and a variety of types processing which can obtain substantially the same result can be used as appropriate.

When power is applied due to an ON operation of a power switch not shown, the control program stored in the storage device 13 starts, and the processor 11 executes the processing operation represented by this flow chart. It should be noted that the process of the processor 11 makes the transition to ACT (n+1) after ACTn (n is a natural number) unless specifically described.

First, the processor 11 executes AC peak voltage control processing in ACT1. The AC peak voltage control processing is processing of setting the AC peak voltages (Vp-p) to be applied to the charging rollers 33K, 33C, 33M, and 33Y of the respective colors of Y, M, C, and K when forming the image.

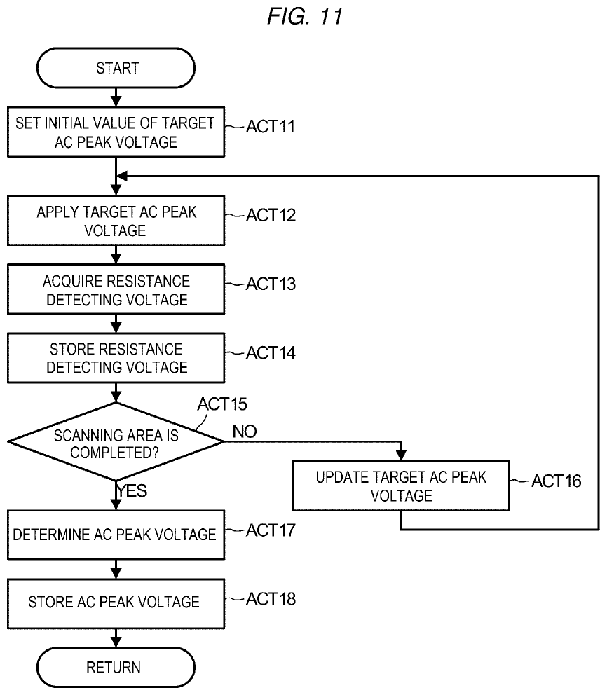

FIG. 11 is a flowchart representing an example of the AC peak voltage control processing in ACT1.

In ACT11, the processor 11 sets an initial value to a target AC peak voltage (Vp-p) as an acquisition target of the resistance detecting voltage. This initial value is, for example, the lowest voltage value of the AC peak voltage (Vp-p) values at the plurality of voltage setting points in the resistance detecting voltage storage unit 131 of the storage device 13. Therefore, in the example shown in FIG. 8, the processor 11 sets 0.5 V as the initial value of the target AC peak voltage (Vp-p).

In ACT12, the processor 11 applies the DC voltage on which the target AC peak voltage (Vp-p) thus set is superimposed to the charging rollers 33K, 33C, 33M, and 33Y of the respective colors of Y, M, C, and K.

In ACT13, the processor 11 acquires the resistance detecting voltage To with the resistance detecting units 21K, 21C, 21M, and 21Y of the respective colors.

In ACT14, the processor 11 stores the resistance detecting voltages To with respect to the respective colors thus obtained in the resistance detecting voltage storage unit 131.

In ACT15, the processor 11 determines whether the scanning area of the AC peak voltage (Vp-p) is completed. For example, when the highest voltage value of the AC peak voltage (Vp-p) values at the plurality of voltage setting points in the resistance detecting voltage storage unit 131 has already been set as the target AC peak voltage (Vp-p), the processor 11 determines that the scanning area has been completed.

Based on the determination that the scanning area has not been completed (NO in ACT15), the processor 11 updates the target AC peak voltage (Vp-p) in ACT16. For example, the voltage value which has not been set out of the AC peak voltage (Vp-p) values at the plurality of voltage setting points in the resistance detecting voltage storage unit 131 is set by the processor 11 as the target AC peak voltage (Vp-p). Subsequently, the processor 11 makes the transition to the processing operation in ACT12 described above.

In ACT17, the processor 11 determines the AC peak voltage (Vp-p) to be applied to the charging rollers 33K, 33C, 33M, and 33Y of the respective colors of Y, M, C, and K based on the determination that the scanning area has been completed (YES in ACT15). For example, the processor 11 calculates the relational expression between the AC peak voltage (Vp-p) stored in the resistance detecting voltage storage unit 131 and the resistance detecting voltage To to obtain the inflection point where the gradient of this relational expression decreases with respect to each of the colors. The processor 11 assumes this inflection point as the saturation point of the surface potential Vo, and determines the AC peak voltage (Vp-p) at the saturation point A as the AC peak voltage (Vp-p) to be applied.

In ACT18, the processor 11 stores the AC peak voltage (Vp-p) to be applied which is determined for each of the colors in the AC peak voltage storage unit 121 of the main memory 12. Subsequently, the processor 11 terminates the AC peak voltage control processing, and then makes the transition to the processing operation in ACT2.

Referring back to the description of FIG. 10, in ACT2, the processor 11 determines whether the print job has been received from the user terminal UT via the communication interface 14. The processor 11 makes the transition to the processing operation in ACT4 described later based on the determination that the print job has not been received (NO in ACT2).

In ACT3, the processor 11 stores the print job thus received in the storage device 13 based on the determination that the print job has been received (YES in ACT2). When the main memory 12 has a sufficient storage capacity, and it is unnecessary to store the print job in a nonvolatile manner, it is possible to store the print job in the main memory 12.

In ACT4, the processor 11 determines whether to start printing. For example, the processor 11 determines to start printing in accordance with input of operation information of a selection operation of the print job as the print target and a start operation subsequent to the selection operation by the user from the operation panel 15. It should be noted that the number of the print jobs as the print target selected can be two or more. The processor 11 makes the transition to the processing operation in ACT2 described above based on the determination not to start printing (NO in ACT4).

In ACT5, the processor 11 executes the resistance detection control processing based on the determination to start printing (YES in ACT4). The resistance detection control processing is the known processing, and is therefore not particularly illustrated. In a brief explanation, in the resistance detection control processing, the processor 11 provides the photoconductor drum with the surface potential (the negative polarity) of any value with respect to each of the colors, and applies an application voltage to the primary transfer roller with a predetermined positive constant current, and acquires the resistance detecting voltage with the resistance detecting unit 21K. Then, the processor 11 sets the voltage value to be applied to the primary transfer roller of each of the colors when forming the image based on the resistance detecting voltage from the resistance detecting unit 21 of each of the colors thus acquired.

In ACT6, the processor 11 executes print control processing of executing one of the print jobs as the print target. The print control processing is the known processing, and is therefore not particularly illustrated. In a brief explanation, in the print control processing, the processor 11 reads one out of the one or more print jobs as the print target selected by the user out of the print jobs stored in the storage device 13, controls the input image processing unit 17 to convert the print target data included in the print job which has been read into the image data, and stores the image data in the page memory 18. Then, the processor 11 controls the output image processing unit 19 in accordance with the control data included in the print job to process the image data stored in the page memory 18 so that the printer 20 can print the image data on the sheet, and controls the printer 20 to print the image data processed by the output image processing unit 19 on the sheet. The processor 11 erases the print job from the storage device 13 in response to the termination of printing corresponding to the print job.

In ACT7, the processor 11 determines whether all the print jobs selected by the user as the print target are completed. Based on the determination that all the print jobs as the print target have not been completed (NO in ACT 7), the processor 11 makes the transition to the processing operation in ACT6 described above to execute printing with respect to the print jobs which has not been executed.

Based on the determination that all the print jobs as the print target have been completed (YES in ACT 7), the processor 11 determines whether to terminate the processing operation in ACT8. For example, when an OFF operation has been performed on the power switch not shown, the processor 11 determines to terminate the processing operation. Based on the determination to terminate the processing operation (YES in ACT8), the processor 11 terminates the processing operation represented by the flowchart in FIG. 10.

In contrast, based on the determination not to terminate the processing operation (NO in ACT8), the processor 11 makes the transition to the processing operation in ACT1 described above to execute the AC peak voltage control processing once again. In this way, every time the image forming operation corresponding to one or more print jobs selected by the user is completed, the AC peak voltage control processing is repeated.

As described above, the image forming apparatus 10 according to the present embodiment is provided with the charging unit, the exposure unit 44 and the developing rollers 42K, 42C, 42M, and 42Y, the primary transfer unit, the resistance detecting units 21K, 21C, 21M, and 21Y, and the processor 11. The charging unit includes the photoconductor drums 30K, 30C, 30M, and 30Y as the image supporters on which the electrostatic latent image is formed, and the charging rollers 33K, 33C, 33M, and 33Y as the charging member adjacent to the surfaces of the photoconductor drums 30K, 30C, 30M, and 30Y, and applies the voltage obtained by superimposing the AC voltage on the DC voltage to the charging rollers 33K, 33C, 33M, and 33Y to thereby homogenously charge the surfaces of the photoconductor drums 30K, 30C, 30M, and 30. The exposure unit 44 and the developing rollers 42K, 42C, 42M, and 42Y form the latent images to be formed on the photoconductor drums 30K, 30C, 30M, and 30Y and then develop the latent images to thereby form the toner images on the photoconductor drums 30K, 30C, 30M, and 30Y. The primary transfer unit transfers the toner images located on the photoconductor drums 30K, 30C, 30M, and 30Y to the transfer body 31 with the primary transfer rollers 36K, 36C, 36M, and 36Y. The resistance detecting units 21K, 21C, 21M, and 21Y detect the resistance values of the primary transfer unit. The processor 11 estimates the saturation values of the surface potentials of the photoconductor drums 30K, 30C, 30M, and 30Y based on the resistance values of the primary transfer unit detected by the resistance detecting units 21K, 21C, 21M, and 21Y, and then sets the AC peak voltages (Vp-p) as the peak values of the AC voltages which are applied by the charging unit to the charging rollers 33K, 33C, 33M, and 33Y in accordance with the saturation values thus estimated. As described above, the charging unit functions as a charger, the exposure unit 44 and the developing rollers 42K, 42C, 42M, and 42Y function as a toner image forming device, the primary transfer unit functions as a primary transfer unit, the resistance detecting units 21K, 21C, 21M, and 21Y function as a detector, and the processor 11 functions as a controller.

As described above, in the image forming apparatus 10 according to the present embodiment provided with the input voltage system which performs the AC-superimposition on the DC power with the charging rollers 33K, 33C, 33M, and 33Y adjacent to the surfaces of the photoconductor drums 30K, 30C, 30M, and 30Y, it is possible to detect the AC peak voltage (Vp-p) and the saturation values A of the surface potentials of the charging rollers 33K, 33C, 33M, and 33Y using the amount of change in the resistance value of the primary transfer unit, and therefore, it is possible to perform the AC peak voltage (Vp-p) setting high in accuracy. In other words, according to the present embodiment, it is possible to provide the image forming apparatus 10 which makes it possible to correctly set the AC voltage peak value to a value in the vicinity of the start of the saturation of the surface potential of the image supporter. Therefore, it becomes possible to provide the image forming apparatus 10 which has enhanced life, and is capable of obtaining a stable image quality while preventing the deterioration of the photoconductor drums 30K, 30C, 30M, and 30Y.

Here, the processor 11 makes the resistance detecting units 21K, 21C, 21M, and 21Y detect the resistance values of the primary transfer unit while making the charging unit change the AC peak voltage (Vp-p), and estimates the saturation values of the surface potentials of the photoconductor drums 30K, 30C, 30M, and 30Y based on the state of the changes in the resistance values of the primary transfer unit detected by the resistance detecting units 21K, 21C, 21M, and 21Y.

As described above, the image forming apparatus 10 according to the present embodiment is capable of easily estimating the saturation values of the surface potentials of the photoconductor drums 30K, 30C, 30M, and 30Y using the state of the changes in the resistance values obtained by scanning the AC peak voltages (Vp-p) to be applied to the charging rollers 33K, 33C, 33M, and 33Y.

Further, the resistance detecting units 21K, 21C, 21M, and 21Y detect the resistance values of the primary transfer unit as the resistance detecting voltages To which are voltage values.

Therefore, since the image forming apparatus 10 according to the present embodiment can use the resistance detecting units 21K, 21C, 21M, and 21Y for detecting the resistance detecting voltages To to be used in the resistance detection control for preventing the image noise, it becomes possible to set the AC peak voltages (Vp-p) to be applied to the charging rollers 33K, 33C, 33M, and 33Y while keeping the configuration of the existing image forming apparatus 10 without adding any new members. Moreover, the image forming apparatus 10 according to the present embodiment is capable of achieving both the reduction of the image noise and the prevention of the deterioration of the photoconductor.

Further, the processor 11 estimates the saturation values of the surface potentials of the photoconductor drums 30K, 30C, 30M, and 30Y based on the saturation values of the resistance detecting voltages To detected by the resistance detecting units 21K, 21C, 21M, and 21Y.

As described above, the image forming apparatus 10 according to the present embodiment capable of easily estimating the saturation values of the surface potentials of the photoconductor drums 30K, 30C, 30M, and 30Y by detecting the saturation values of the resistance detecting voltages To focusing attention on the fact that the resistance detecting voltages To and the surface potentials of the photoconductor drums 30K, 30C, 30M, and 30Y take substantially the same state of change with respect to the change in the AC peak voltages (Vp-p).

Further, the primary transfer unit is provided with the transfer body 31, and the primary transfer rollers 36K, 36C, 36M, and 36Y which are biasing members opposed to the photoconductor drums 30K, 30C, 30M, and 30Y across the transfer body 31, and biases the transfer body 31 toward the photoconductor drums 30K, 30C, 30M, and 30Y to make the transfer body 31 come into contact with the photoconductor drums 30K, 30C, 30M, and 30Y to thereby transfer the toner images on the photoconductor drums 30K, 30C, 30M, and 30Y to the transfer body 31, and each of the resistance detecting units 21K, 21C, 21M, and 21Y detects the resistance value of the resistive element including the transfer body 31 and corresponding one of the primary transfer rollers 36K, 36C, 36M, and 36Y.

As described above, in the image forming apparatus 10 according to the present embodiment, the resistance detecting units 21K, 21C, 21M, and 21Y are each capable of detecting the resistance value of the resistive element including the transfer body and corresponding one of the primary transfer rollers 36K, 36C, 36M, and 36Y as the resistance value of the primary transfer unit.

The embodiment is hereinabove described, but the embodiment is not limited thereto.

For example, in the embodiment, there is presented the description citing the image forming apparatus 10 which forms the image with the four colors of Y, M, C, and K as an example, but the image forming apparatus can be a monochrome image forming apparatus such as a black image forming apparatus.

Further, the resistance detecting voltage storage unit 131 and the AC peak voltage storage unit 121 are not limited to those storing data in such a table format as shown in FIG. 8 and FIG. 9.

Further, the print operation is described with reference to the flowchart in FIG. 10, and it is possible to execute the AC peak voltage control processing every time the copying operation of one or more documents is completed also in the copying operation using the scanner 16.

Further, in the image forming apparatus having a sleep mode for power saving, it is also possible to arrange that the AC peak voltage control processing is executed when restored from the sleep state, or is executed in accordance with a use situation of the image forming apparatus such as when a certain operating time elapses, or when images of a certain number of sheets are formed.

Further, in the AC peak voltage control processing shown in detail in FIG. 11, in addition to storing the AC peak voltage (Vp-p) which has been determined in the AC peak voltage storage unit 121, it is possible to transmit the AC peak voltage (Vp-p) which has been determined to the server device SV via the communication interface 14. Thus, for example, it becomes possible for the server device SV to detect the prospect of failures of the image forming apparatus 10 by determining whether the AC peak voltage (Vp-p) which has been transmitted therefrom is within the stipulated range. When there is the prospect of failures of the image forming apparatus 10, it is possible for the server device SV to send feedback to the image forming apparatus 10 so as not to use the AC peak voltage (Vp-p), or to notify a maintenance staff of the image forming apparatus 10 or a service personnel of a maintenance service company.

Further, in the embodiment described above, it is assumed that the control program is stored in advance in the storage device 13 of the image forming apparatus 10. Regarding this point, the control program distributed separately from the image forming apparatus 10 can be written in a storage device which is writable and is provided to the image forming apparatus 10 in accordance with an operation of an administrator or the like. The distribution of such a control program can be achieved by storing it in a removable computer-readable storage medium, or communication via a network. The computer readable storage medium can have any configuration providing the computer readable storage medium is capable of storing the programs and is capable of been read by the apparatus like a CD-ROM, a memory card, or the like.

In addition, although some embodiments of the present disclosure are described, these embodiments are illustrative only, but it is not intended to limit the scope of the present disclosure. These novel embodiments can be implemented with other various aspects, and a variety of omissions, replacements, and modifications can be made within the scope or the spirit of the present disclosure. These embodiments are included in the scope of the present disclosure, and at the same time, included in the present disclosure set forth in the appended claims, and the equivalents thereof.

What is claimed is:

1. An image forming apparatus, comprising:
an image supporter provided with an electrostatic latent image;
a charger which includes a charging member adjacent to a surface of the image supporter, and which is configured to apply a voltage obtained by superimposing an AC voltage on a DC voltage to the charging member to thereby homogenously charge the surface of the image supporter;
a toner image forming device configured to form a latent image to be provided to the image supporter and then develop the latent image to thereby form a toner image on the image supporter;
a transfer device configured to transfer the toner image from the image supporter to a transfer body;
a detector configured to detect a resistance value of the transfer device; and
a controller configured to estimate a saturation value of a surface potential of the image supporter based on the resistance value of the transfer device detected by the detector, and then set a peak value of the AC voltage which is applied by the charger to the charging member, in accordance with the saturation value estimated.

2. The image forming apparatus according to claim 1, wherein
the controller is further configured to make the detector detect the resistance value of the transfer device while making the charger change the peak value of the AC voltage, and then estimate the saturation value of the surface potential of the image supporter based on a state of a change in the resistance value of the transfer device detected by the detector.

3. The image forming apparatus according to claim 2, wherein
the detector is further configured to detect the resistance value of the transfer device as a voltage value.

4. The image forming apparatus according to claim 3, wherein
the controller is further configured to estimate the saturation value of the surface potential of the image supporter based on a saturation value of the voltage detected by the detector.

5. The image forming apparatus according to claim 3, wherein
the detector is further configured to output the resistance value of the transfer device to a processor.

6. The image forming apparatus according to claim 5, wherein
the processor is configured to store the resistance value in a resistance detecting voltage storage component.

7. The image forming apparatus according to claim 1, wherein
the transfer device includes the transfer body, and a biasing member opposed to the image supporter across the transfer body, and is configured to bias the transfer body toward the image supporter with the biasing member to make the transfer body come into contact with the image supporter to thereby transfer the toner image on the image supporter to the transfer body, and
the detector is further configured to detect a resistance value of a resistive element including the transfer body and the biasing member.

8. A method of controlling an image forming apparatus including an image supporter provided with an electrostatic latent image, a charger configured to apply a voltage obtained by superimposing an AC voltage on a DC voltage to a charging member adjacent to a surface of the image supporter to thereby homogenously charge the surface of the image supporter, a toner image forming device configured to form a latent image to be provided to the image supporter and then develop the latent image to thereby form a toner image on the image supporter, a transfer device configured to transfer the toner image from the image supporter to a transfer body, and a detector configured to detect a resistance value of the transfer device, the method comprising:
estimating a saturation value of a surface potential of the image supporter based on a resistance value of the transfer device detected by the detector; and
setting a peak value of the AC voltage which is applied by the charger to the charging member, in accordance with the saturation value estimated.

9. The method according to claim 8, further comprising:
detecting the resistance value of the transfer device while making the charger change the peak value of the AC voltage; and then
estimating the saturation value of the surface potential of the image supporter based on a state of a change in the resistance value of the transfer device detected by the detector.

10. The method according to claim 9, further comprising:
detecting the resistance value of the transfer device as a voltage value.

11. The method according to claim 10, further comprising:
estimating the saturation value of the surface potential of the image supporter based on a saturation value of the voltage detected by the detector.

12. The method according to claim 10, further comprising:
outputting the resistance value of the transfer device to a processor.

13. The method according to claim 12, further comprising:
storing the resistance value in a resistance detecting voltage storage component.

14. The method according to claim 8, wherein
the transfer device includes the transfer body, and a biasing member opposed to the image supporter across the transfer body, further comprising:
is configured to bias the transfer body toward the image supporter with the biasing member to make the transfer body come into contact with the image supporter to thereby transfer the toner image on the image supporter to the transfer body, and
the detector is further configured to detect a resistance value of a resistive element including the transfer body and the biasing member.

15. A printer, comprising:
a printing component;
an image supporter provided with an electrostatic latent image;
a charger which includes a charging member adjacent to a surface of the image supporter, and which is configured to apply a voltage obtained by superimposing an AC voltage on a DC voltage to the charging member to thereby homogenously charge the surface of the image supporter;
a toner image forming device configured to form a latent image to be provided to the image supporter and then develop the latent image to thereby form a toner image on the image supporter;
a transfer device configured to transfer the toner image from the image supporter to a transfer body;
a detector configured to detect a resistance value of the transfer device; and
a controller configured to estimate a saturation value of a surface potential of the image supporter based on the resistance value of the transfer device detected by the detector, and then set a peak value of the AC voltage which is applied by the charger to the charging member, in accordance with the saturation value estimated.

16. The printer according to claim 15, wherein
the controller is further configured to make the detector detect the resistance value of the transfer device while making the charger change the peak value of the AC voltage, and then estimate the saturation value of the surface potential of the image supporter based on a state of a change in the resistance value of the transfer device detected by the detector.

17. The printer according to claim 16, wherein
the detector is further configured to detect the resistance value of the transfer device as a voltage value.

18. The printer according to claim 17, wherein
the controller is further configured to estimate the saturation value of the surface potential of the image supporter based on a saturation value of the voltage detected by the detector.

19. The printer according to claim 17, wherein
the detector is further configured to output the resistance value of the transfer device to a processor.

20. The printer according to claim 19, wherein
the processor is configured to store the resistance value in a resistance detecting voltage storage component.
